(19) United States
(12) Patent Application Publication
(10) Pub. No.: US 2025/0088144 A1
(43) Pub. Date: Mar. 13, 2025

(54) PHOTOVOLTAIC SYSTEM, INVERTER STARTING METHOD AND PHOTOVOLTAIC ENERGY STORAGE SYSTEM

(71) Applicant: Sungrow Power Supply Co., Ltd., Hefei (CN)

(72) Inventors: Haitao Li, Hefei (CN); Huan Nie, Hefei (CN); Lin Cheng, Hefei (CN)

(73) Assignee: Sungrow Power Supply Co., Ltd., Hefei (CN)

(21) Appl. No.: 18/723,822

(22) PCT Filed: Nov. 28, 2022
(86) PCT No.: PCT/CN2022/134751

§ 371 Date: Jun. 24, 2024

(30) Foreign Application Priority Data
Apr. 20, 2022 (CN) 202210417009.7

(51) Int. Cl. H02S 40/32; H02H 7/20; H02J 3/38

(52) U.S. Cl. CPC H02S 40/32; H02H 7/20; H02J 3/38; H02J 2300/24

(57) ABSTRACT

A photovoltaic system, an inverter starting method and a photovoltaic energy storage system are provided. The photovoltaic system includes: a shutdown device, a controller and an inverter. The inverter includes a DC-DC circuit and an inverter circuit; the DC-DC circuit includes at least two Boost circuits; an input terminal of the shutdown device is connected to a photovoltaic panel, and an output terminal of the shutdown device is connected to an input terminal of the DC-DC circuit; an output terminal of the DC-DC circuit is connected to an input terminal of the inverter circuit. The method includes: controlling the inverter to perform a start-up process in multiple stages in a case that a start-up time of the inverter is greater than a single turned-on period of the shutdown device, where the shutdown device is turned on once in each of the multiple stages.

The present application claims priority to Chinese Patent Application No. 202210417009.7, titled “PHOTOVOLTAIC SYSTEM, INVERTER STARTING METHOD AND PHOTOVOLTAIC ENERGY STORAGE SYSTEM”, filed on Apr. 20, 2022 with the China National Intellectual Property Administration, which is incorporated herein by reference in its entirety.

### FIELD

The present disclosure relates to the technical field of photovoltaic power generation, in particular to a photovoltaic system, a method for starting an inverter and a photovoltaic energy storage system.

### BACKGROUND

Currently, with the development of photovoltaic power generation, the safety of the photovoltaic systems attracts much attention. Generally, a photovoltaic system includes a shutdown device, and the shutdown device is controlled to disconnect the photovoltaic panel from the inverter when it is necessary.

Reference is made to FIG. 1, which is a schematic diagram of a photovoltaic system.

The shutdown device 200 is connected between the photovoltaic panel 100 and the inverter 300. When the inverter 300 in the photovoltaic system fails and requires maintenance, it is required to disconnect the photovoltaic panel 100 from the input terminal of the inverter 300 stably and reliably, so that the direct-current side of the inverter 300 is powered off to ensure personal safety of the maintenance personnel.

In the conventional technology, no communication exists between the shutdown device 200 and the inverter 300, when the inverter 300 starts, the shutdown device 200 starts. However, when the inverter 300 starts, since the inverter 300 has not yet been connected to the grid, the inverter 300 does not output power, that is, the input current of the inverter 300 is very small or almost 0, and the shutdown device 200 will shut down when its output current is detected to be less than a preset value. In this case, the voltage across the input terminal of the inverter 300 is zero, causing the inverter 300 to fail to start successfully.

### SUMMARY

In view of this, a photovoltaic system, a method for starting an inverter and a photovoltaic energy storage system are provided according to embodiments of the present disclosure, with which the inverter can be started successfully in a case of a shutdown device.

A photovoltaic system is provided in the present disclosure, including a shutdown device, a controller and an inverter. The inverter includes a direct-current to direct-current circuit and an inverter circuit, and the direct-current to direct-current circuit includes at least a Boost circuit. An input terminal of the shutdown device is connected to a photovoltaic panel, and an output terminal of the shutdown device is connected to an input terminal of the direct-current to direct-current circuit; an output terminal of the direct-current to direct-current circuit is connected to an input terminal of the inverter circuit. The controller is configured to control the inverter to perform a start-up process in multiple stages in a case that a start-up time of the inverter is greater than a single turned-on period of the shutdown device, where the shutdown device is turned on once in each of the multiple stages.

Preferably, the multiple stages include at least: an insulation resistance detection stage, a relay detection stage, and an inverter open-loop self-test stage. A relay is connected with an output terminal of the inverter; and the controller is further configured to control, if the start-up process fails in at least one of the multiple stages, the inverter to re-perform the start-up process in multiple stages.

Preferably, during the start-up process of the inverter, the controller is further configured to turn on the shutdown device and turn off the shutdown device in a case that a single turned-on period is over; and turn on the shutdown device again, and perform insulation resistance detection in a case that the shutdown device is turned on.

Preferably, the shutdown device is turned off after the insulation resistance detection is performed by the controller, and the shutdown device is turned on again by the controller, and relay self-test is performed in a case that the shutdown device is turned on.

Preferably, the shutdown device is turned off after the relay self-test is performed by the controller, and the shutdown device is turned on again by the controller, and the controller is configured to perform power self-test of the inverter in a case that the shutdown device is turned on, and further configured to close the relay after the power self-test of the inverter is performed.

Preferably, the shutdown device is further configured to detect an output current of the shutdown device and is turned off if the output current is less than a preset current.

Preferably, the input terminal of the inverter circuit is connected to at least one Boost circuit.

A method for starting an inverter of a photovoltaic system is further provided in the present disclosure, where the photovoltaic system includes: a shutdown device, a controller and an inverter; the inverter includes a direct-current to direct-current circuit and an inverter circuit; the direct-current to direct-current circuit includes at least two Boost circuits; an input terminal of the shutdown device is connected to a photovoltaic panel, and an output terminal of the shutdown device is connected to an input terminal of the direct-current to direct-current circuit; an output terminal of the direct-current to direct-current circuit is connected to an input terminal of the inverter circuit. The method includes: controlling the inverter to perform a start-up process in multiple stages in a case that a start-up time of the inverter is greater than a single turned-on period of the shutdown device, where the shutdown device is turned on once in each of the multiple stages.

Preferably, the multiple stages include at least: an insulation resistance detection stage, a relay detection stage, and an inverter open-loop self-test stage; where the relay is connected to an output terminal of the inverter. The method further includes: controlling the inverter to re-perform the start-up process in multiple stages in a case that the start-up process fails in at least one of the multiple stages.

Preferably, performing insulation resistance detection in a case that the shutdown device is turned on includes:
during the start-up process of the inverter, turning on the shutdown device, and turning off the shutdown device in a case that a set delay period is over; and turning on the shutdown device again by the controller, and performing the insulation resistance detection by the controller in a case that the shutdown device is turned on.

Preferably, performing bus voltage generation in a case that the shutdown device is turned on includes:
turning on the shutdown device again; and performing relay self-test in a case that the shutdown device is turned on.

Preferably, performing power self-test of the inverter in a case that the shutdown device is turned on includes:
turning on the shutdown device again, and performing power self-test of the inverter by the controller in a case that the shutdown device is turned on, and controlling the relay to be closed by the controller after the power self-test of the inverter is performed.

A photovoltaic energy storage system is further provided in the present disclosure, and the photovoltaic energy storage system includes: a shutdown device, a controller, a first direct-current to direct-current circuit, a second direct-current to direct-current circuit and an inverter circuit. The first direct-current to direct-current circuit includes at least a Boost circuit, and the first direct-current to direct-current circuit and the inverter circuit are arranged in an inverter. An input terminal of the shutdown device is connected to a photovoltaic panel, and an output terminal of the shutdown device is connected to an input terminal of the first direct-current to direct-current circuit; an output terminal of the first direct-current to direct-current circuit is connected to an input terminal of the inverter circuit; the second direct-current to direct-current circuit is a bidirectional direct-current to direct-current circuit, a first terminal of the second direct-current to direct-current circuit is connected to an input terminal of the inverter circuit, and a second terminal of the second direct-current to direct-current circuit is configured to connect to an energy storage battery. The controller is configured to control the inverter to perform a start-up process in multiple stages in a case that a start-up time of the inverter is greater than a single turned-on period of the shutdown device, where the shutdown device is turned on once in each of the multiple stages.

It can be seen that the embodiments of the present disclosure have the following beneficial effects.

In order to start the inverter normally, the start-up process of the inverter is divided into multiple stages. Since a start-up time of the inverter is greater than a single turned-on duration of the shutdown device, the shutdown device is awakened once in each stage, that is, the shutdown device is turned on, so that the voltage is applied to the input terminal of the inverter, to perform the start-up process of the inverter. Since the output terminal of the inverter is not connected to the grid, during the start-up process of the inverter and in a case that the shutdown device is turned on, if the shutdown device detects that its parameter meets a turned-off condition, the shutdown device will be automatically turned off. In this case, the start-up process of the inverter is not completed, it is required to re-awake the shutdown device, and the awakening process repeats until the inverter is started successfully. The above method has great significance especially for the case that the input terminal of the inverter is connected to only one photovoltaic string with a shutdown device. Conventionally, in a case that the input terminal of the inverter is connected to multiple shutdown devices, the shutdown devices may be controlled to be turned-on separately to provide voltages to the input terminal of the inverter to perform the start-up process of the inverter. However, in a case that only one shutdown device is connected to the input terminal of the inverter, the inverter cannot be started successfully with the conventional method.

### BRIEF DESCRIPTION OF THE DRAWINGS

FIG. 1 is a schematic diagram of a photovoltaic system;

FIG. 2 is a schematic diagram of a shutdown device;

FIG. 3 is a schematic diagram of a photovoltaic system according to an embodiment of the present disclosure;

FIG. 4 is a schematic diagram of a photovoltaic system according to another embodiment of the present disclosure;

FIG. 5 is a schematic diagram of a photovoltaic system according to another embodiment of the present disclosure;

FIG. 6 is a flowchart of a method for starting an inverter of a photovoltaic system according to an embodiment of the present disclosure; and

FIG. 7 is a schematic diagram of a photovoltaic energy storage system according to an embodiment of the present disclosure.

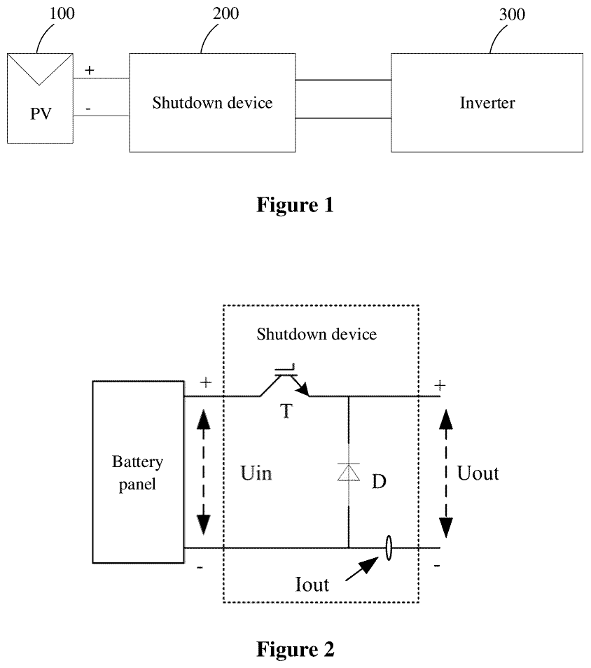

### DETAILED DESCRIPTION

In order to enable those skilled in the art to better understand the technical solutions according to the present disclosure, specific application scenarios are first described below.

In order to ensure the safety of the inverter in the photovoltaic system according to the embodiment of the present disclosure, it is required to decrease a voltage between a terminal of the inverter and the ground to less than or equal to 30V within 30 seconds after the shutdown device is turned off, for example, the input and output voltages of the inverter are both need to be decreased to less than or equal to 30V within 30 s.

However, in a photovoltaic system provided with a shutdown device, no communication exists between the inverter and the shutdown device, and the switching state of the shutdown device depends on changes in a voltage and a current of the shutdown device. For example, a current condition for turning off the shutdown device is: in a case that a controller of the shutdown device detects a state that an output voltage of the shutdown device remains unchanged and an output current is less than a preset current and the state lasts for more than 10 seconds, the controller controls the shutdown device to be turned off.

Reference is made to FIG. 2, which is a schematic diagram of a shutdown device.

At present, a controller of a shutdown device mainly determines whether to control the shutdown device to be turned off based on parameters such as an input voltage (Uin) of the shutdown device (as shown in FIG. 2, that is, an output voltage of a cell panel), an output voltage (Uout) of the shutdown device, an output current (Iout) of the shutdown device.

However, during the start-up process of the inverter, since an output side of the inverter is not connected to the grid, a voltage and a current on an input side of the inverter (that is, corresponding to a voltage and a current on an output side of the shutdown device) meets a condition for turning off the shutdown device, and the start-up time of the inverter is generally more than 30 seconds. Therefore, the shutdown device is turned off untimely during the start-up process of the inverter, and the inverter cannot be started normally. That is, in a photovoltaic system with a shutdown device, a turned-off condition of the shutdown device is triggered during the normal start-up process of the inverter since no direct communication exists between the inverter and the shutdown device, which causes the shutdown device to be turned off repeatedly, affecting the normal start-up of the inverter.

Therefore, in the photovoltaic system according to the embodiment of the present disclosure, in order to start the inverter normally, the start-up process of the inverter is divided into multiple stages, and the shutdown device is awakened once in each stage, that is, the shutdown device is turned on once in each stage, so that the voltage is applied to the input terminal of the inverter, to perform the start-up process of the inverter. Since the output terminal of the inverter is not connected to the grid, during the start-up process of the inverter and after the shutdown device is awakened, if the shutdown device detects that its parameter meets a turned-off condition, the shutdown device will be automatically turned off. In this case, the start-up process of the inverter is not completed, it is required to re-awake the shutdown device, and the awakening process repeats until the inverter is started successfully. The above method has great significance for the case that the input terminal of the inverter is connected to only one photovoltaic string with a shutdown device. Conventionally, in a case that the input terminal of the inverter is connected to multiple shutdown devices, the shutdown devices may be controlled to be turned-on separately to provide voltages to the input terminal of the inverter in order to complete the start-up process of the inverter. However, in a case that only one shutdown device is connected to the input terminal of the inverter, the inverter cannot be started successfully with the conventional method.

### Embodiments of the Photovoltaic System

The photovoltaic system according to the embodiment of the present disclosure is described in detail below in conjunction with the drawings.

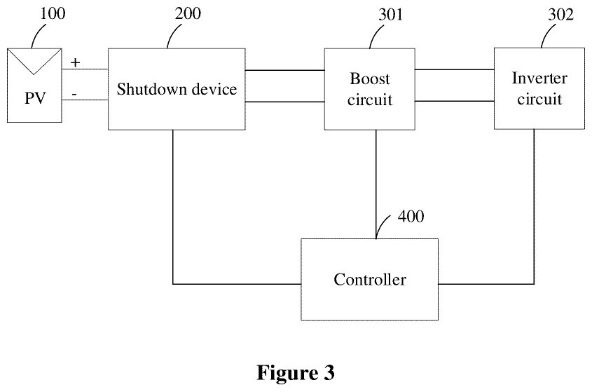

Reference is made to FIG. 3, which is a schematic diagram of a photovoltaic system according to an embodiment of the present disclosure.

The photovoltaic system according to the embodiment of the present disclosure is described by taking an inverter including two stages as an example, that is, the inverter includes a direct-current to direct-current (DC-DC) circuit and an inverter direct-current to alternating-current (DC-AC) circuit 302. Here, a direct-current to direct-current circuit including at least a Boost circuit 301 is described as an example.

As shown in FIG. 3, the photovoltaic system according to the present embodiment includes: a shutdown device 200, a controller 400, a direct-current to direct-current circuit and an inverter circuit 302, where the direct-current to direct-current circuit includes at least a Boost circuit 301. An input terminal of the shutdown device 200 is connected to a photovoltaic panel 100, and an output terminal of the shutdown device 200 is connected to an input terminal of the direct-current to direct-current circuit; an output terminal of the direct-current to direct-current circuit is connected to an input terminal of the inverter circuit 302; that is, an output terminal of the Boost circuit 301 is connected to the input terminal of the inverter circuit 302. The controller 400 is configured to control the inverter to perform a start-up process in multiple stages in a case that a start-up time of the inverter is greater than a turned-on period of the shutdown device, where the shutdown device is turned on once in each stage.

For example, the multiple stages include at least: an insulation resistance detection stage, a relay detection stage, and an inverter open-loop self-test stage.

Generally, in order to connect to the grid, the inverter goes through the following stages from being powered-on to being grid-connected: an input condition determination stage (whether an input voltage meets the start-up condition), a system setting delay stage (an alarm recovery delay or a normal start-up delay, etc.), an insulation resistance detection stage, a bus voltage generation stage (no detection is required at this stage), a grid-connected relay self-test stage, an open-loop wave self-test stage, and a relay closing stage, and the like.

It should be understood that a power self-test is also called an open-loop self-test or an open-loop wave self-test, which is performed to mainly detect whether the energy in the system is sufficient for the switching tube in the inverter to switch normally.

In a case that the shutdown device is turned on, a voltage across the photovoltaic panel increases rapidly. For example, in a case that the voltage across the photovoltaic panel is maintained for 10 seconds, the voltage across the photovoltaic panel begins to decrease due to the turn-off of the shutdown device. In a case that the voltage across the photovoltaic panel decreases below a preset voltage, the shutdown device is triggered to be turned on, and the voltage across the photovoltaic panel is re-generated.

In order to start the inverter normally, the start-up process of the inverter is compressed and divided into several stages in the present disclosure. On one hand, the detection and execution time of each step is compressed, to shorten the total time of the start-up process. On the other hand, part of steps of the start-up process of the inverter are performed within a single turned-on period of the shutdown device (for example, a default period is 10 s) each time after the shutdown device is turned on. When the shutdown device is turned off after the current turned-on period of the shutdown device is over, the shutdown device is turned on again to perform a next part of steps of the start-up process of the inverter. Therefore, the shutdown device is turned on repeatedly for multiple number of times during the start-up process of the inverter, so that the inverter is started successfully.

The number of stages during the start-up process of the inverter is not specifically limited in the embodiment of the present disclosure, which may be set according to actual needs, as long as steps that need to be performed during a single turned-on period of the shutdown device are completed in the stage.

In addition, the controller is further configured to control the inverter to re-start in a case that the start-up process fails in at least one of the multiple stages, that is, to re-perform the start-up process of the inverter in multiple stages.

The number of shutdown devices connected to the input terminal of the inverter is not limited in the embodiment of the present disclosure, and the number of Boost circuits connected to the input terminal of the inverter is also not limited in the embodiment of the present disclosure. In the following, the input terminal of the inverter connected to multiple Boost circuits is described as an example. In addition, the number of shutdown devices corresponding to one Boost circuit is not specifically limited in the present disclosure. One Boost circuit may correspond to one shutdown device, or one Boost circuit may correspond to multiple shutdown devices. For example, in the following embodiment, one Boost circuit corresponding to one shutdown device is described.

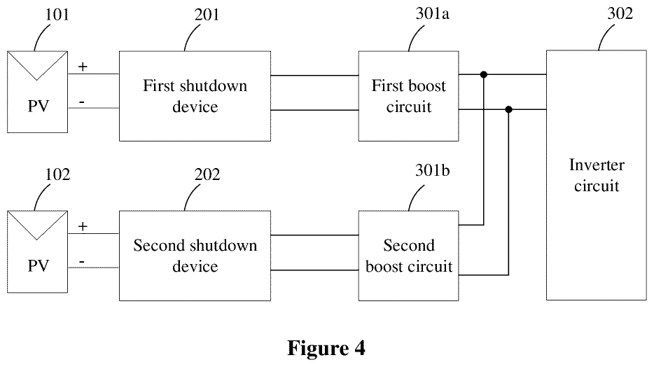

Reference is made to FIG. 4, which is a schematic diagram of a photovoltaic system according to another embodiment of the present disclosure.

In this embodiment, the input terminal of the inverter circuit 302 connecting to two Boost circuits is taken as an example.

The input terminal of the first shutdown device 201 is connected to the first photovoltaic panel 101, the output terminal of the first shutdown device 201 is connected to the input terminal of the first Boost circuit 301a, and the output terminal of the first Boost circuit 301a is connected to the input terminal of the inverter circuit 302.

Similarly, the input terminal of the second shutdown device 202 is configured to connect to the second photovoltaic panel 102, the output terminal of the second shutdown device 202 is connected to the input terminal of the second Boost circuit 301b, and the output terminal of the second Boost circuit 301b is connected to the input terminal of the inverter circuit 302, that is, the output terminal of the first Boost circuit 301a and the output terminal of the second Boost circuit 301b are connected in parallel.

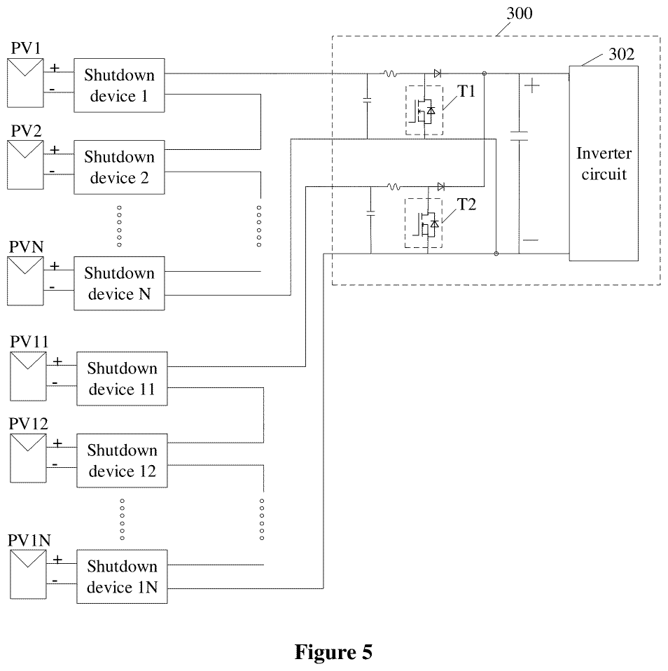

Reference is made to FIG. 5, which is a schematic diagram of a photovoltaic system according to another embodiment of the present disclosure.

In FIG. 5, one Boost circuit in the photovoltaic system corresponds to multiple shutoff devices.

The inverter 300 in FIG. 5 includes a Boost circuit and an inverter circuit 302. In FIG. 5, the input terminal of the inverter circuit 302 connecting to two Boost circuits is taken as an example.

The input terminal of the first Boost circuit is connected to the shutdown device 1, the shutdown device 2 . . . and shutdown device N, that is, the output terminal of the shutdown device 1, the output terminal of the shutdown device 2 . . . and the output terminal of the shutdown device N are connected in series and then connected to the input terminal of the first Boost circuit. The input terminal of shutdown device 1 is connected to the first photovoltaic panel PV1, the input terminal of shutdown device 2 is connected to the second photovoltaic panel PV2 . . . and the input terminal of the shutdown device N is connected to the N-th photovoltaic panel PVN.

Similarly, The input terminal of the second Boost circuit is connected to the shutdown device 11, the shutdown device 12 . . . and shutdown device 1N, that is, the output terminal of the shutdown device 11, the output terminal of the shutdown device 12 . . . and the output terminal of the shutdown device 1N are connected in series and then connected to the input terminal of the second Boost circuit. The input terminal of shutdown device 11 is connected to the first photovoltaic panel PV11, the input terminal of shutdown device 12 is connected to the second photovoltaic panel PV12 . . . and the input terminal of the shutdown device 1N is connected to the 1 N-th photovoltaic panel PV1N.

The solution of starting the inverter according to the embodiment of the present disclosure is applicable to the case that the input terminal of the inverter is connected with one photovoltaic string, and is also applicable to the case that the input terminal of the inverter is connected to multiple photovoltaic strings. The inverter including a direct-current to direct-current (DC-DC) circuit and a direct-current to alternating-current (DC-AC) circuit connected in series is taken as an example in the embodiment of the present disclosure. In addition, the technical solution according to the embodiment of the present disclosure may also be applied to the case that the inverter only includes a direct-current to alternating-current circuit.

Several important stages in the start-up process of the inverter are described in the following.

The controller is specifically configured to, during the start-up process of the inverter, turn on the shutdown device and turn off the shutdown device in a case that a single turned-on period is over; and turn on the shutdown device again, and perform insulation resistance detection in a case that the shutdown device is turned on.

It should be understood that the set delay time is not specifically limited in the embodiment of the present disclosure, and the set delay time is set by the photovoltaic system. Since the shutdown device keeps detecting its own parameters and determining whether to be turned off based on its own parameters, the shutdown device may be turned off when the set delay time is over, the process haven't proceeded to a next stage, for example, the insulation resistance detection stage. Therefore, in order to proceed to the insulation resistance detection stage normally, the insulation resistance detection is performed in a case that the shutdown device is turned on next time. The insulation resistance detection is performed preferably within the turned-on period of the shutdown device, for example, within 10 seconds. After the shutdown device is turned off, the shutdown device is turned on again. Whether the shutdown device is turned off may be determined based on a voltage of the photovoltaic string, and if the voltage is less than a preset voltage, it is determined that the shutdown device is turned off.

The shutdown device is turned off after the insulation resistance test is performed by the controller, and the shutdown device is turned on again by the controller. In a case that the shutdown device is turned on, the controller performs relay self-test, where the relay is connected to the output terminal of the inverter. The inverter is connected to the alternating grid in a case that the relay connected to the output terminal of the inverter is turned on.

In a case that the shutdown device is turned on, a bus voltage is generated. In this case, the relay self-test may be performed to determine whether the relay can operate normally, that is, whether the relay can be turned on and turned off normally.

The shutdown device is turned off after the relay self-test is performed by the controller, and the shutdown device is turned on again by the controller. When the shutdown device is turned on, the controller is configured to perform open-loop self-test for the inverter, and close the relay after the open-loop self-test of the inverter is performed.

The shutdown device is specifically configured to detect the output current of the shutdown device and is turned off if the output current is less than a preset current. In addition, the shutdown device may also detect another parameter to determine whether to be turned off, such as an input voltage, and an output voltage. For example, in a case of detecting that the output voltage is unchanged and the output current is less than the preset current, the shutdown device is turned off.

With the photovoltaic system according to the embodiment of the present disclosure, the shutdown device is turned on for multiple number of times during the start-up process of the inverter. Each time the inverter is turned on, a part of steps of the start-up process is performed, so that a part of the start-up process is performed at each stage. The shutdown device is turned on for multiple number of times to perform the whole start-up processes of the inverter, so that the inverter is started successfully.

### Embodiments of the Method

Based on the photovoltaic system according to the above embodiments, a method for starting an inverter of the photovoltaic system is provided according to an embodiment of the present disclosure, which is described in detail below in conjunction with the drawings.

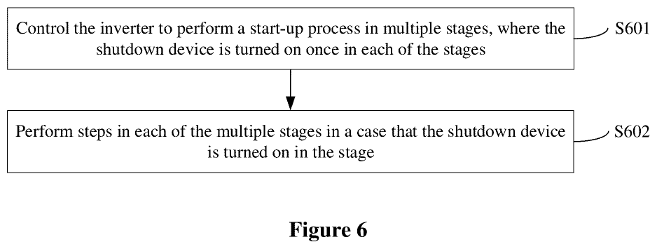

Reference is made to FIG. 6, which is a flowchart of a method for starting an inverter of a photovoltaic system according to an embodiment of the present disclosure.

In the method for starting an inverter of a photovoltaic system according to the present embodiment, the photovoltaic system includes: a shutdown device, a controller and an inverter. The inverter includes a direct-current to direct-current circuit and an inverter circuit, the direct-current to direct-current circuit includes at least two Boost circuits. An input terminal of the shutdown device is connected to a photovoltaic panel, and an output terminal of the shutdown device is connected to an input terminal of the direct-current to direct-current circuit. An output terminal of the direct-current to direct-current circuit is connected to an input terminal of the inverter circuit. It should be understood that the method in the embodiment of the present disclosure is also applicable to a case that the input terminal of the inverter circuit is connected to one Boost circuit. In a case that the input terminal of the inverter circuit is connected to multiple Boost circuits, the multiple Boost circuits can be turned on/off simultaneously.

The method includes steps S601 and S602.

In step S601, the inverter is controlled to be started in multiple stages of the start-up process in a case that the start-up time of the inverter is greater than a single turned-on period of the shutdown device, and the shutdown device is turned on once in each stage.

In step S602, each time the shutdown device is turned on, one of the stages is performed.

The stages sequentially include: an insulation resistance detection stage, a relay detection stage, and an inverter power self-test stage. It should be understood that the power self-test is also called open-loop self-test, which is performed to mainly detect whether the energy in the system is sufficient for the switching tube in the inverter to be switched normally.

In addition, it should be noted that the method further includes: controlling the inverter to re-perform the start-up process multiple stages in a case that the start-up process fails in at least one of the multiple stages, that is, to restart the inverter.

Performing insulation resistance detection in a case that the shutdown device is turned on includes:
during the start-up process of the inverter, turning on the shutdown device, and turning off the shutdown device after a single turned-on period; turning on the shutdown device again by the controller, and the controller performs insulation resistance detection in a case that the shutdown device is turned on.

Performing bus voltage generation in a case that the shutdown device is turned on includes:
turning on the shutdown device again to generate the bus voltage.

The method further includes: performing relay self-test, where the relay is connected to the output terminal of the inverter. That is, the bus voltage generation and relay self-test are performed in the same stage after the shutdown device is turned on.

Performing open-loop self-test of the inverter in a case that the shutdown device is turned on includes:
turning on the shutdown device again, and the controller performs open-loop self-test of the inverter in a case that the shutdown device is turned on, and also controls the relay to be closed after the open-loop self-test of the inverter is performed.

In order to start the inverter normally, the start-up process of the inverter is compressed and divided into several stages in the present disclosure. On one hand, the detection and execution time of each step is compressed, to shorten the total time of the start-up process. On the other hand, part of steps of the start-up process of the inverter are performed within a single turned-on period of the shutdown device (for example, a default period is 10 s) each time after the shutdown device is turned on. When the shutdown device is turned off after the current turned-on period of the shutdown device is over, the shutdown device is turned on again to perform a next part of steps of the start-up process of the inverter. Therefore, the shutdown device is turned on repeatedly for multiple number of times during the start-up process of the inverter, so that the inverter is started successfully.

### Embodiments of the Photovoltaic Energy Storage System

Based on the photovoltaic system and the method for starting the inverter provided in the above embodiments, a photovoltaic energy storage system is further provided according to an embodiment of the present disclosure, which is described in detail below in junction with the drawings.

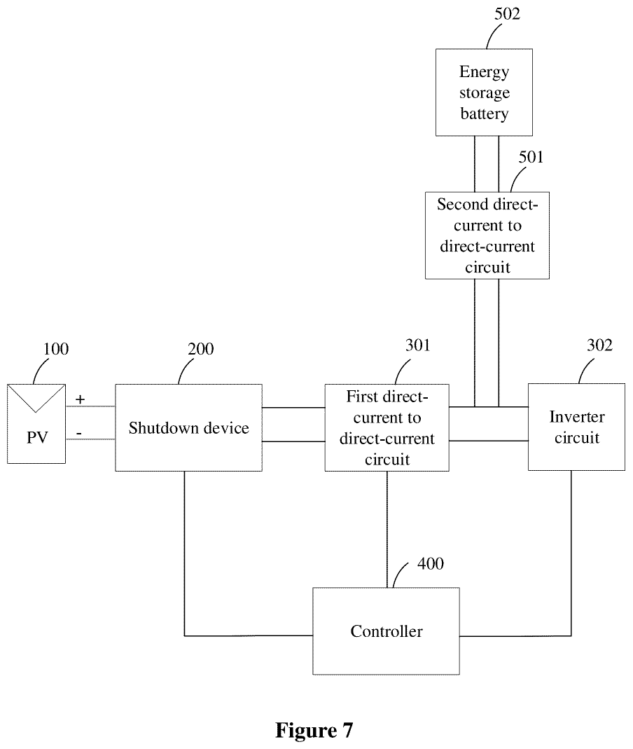

Reference is made to FIG. 7, which is a schematic diagram of a photovoltaic energy storage system according to an embodiment of the present disclosure.

The energy storage system in the present disclosure includes: a shutdown device 200, a controller 400, a first direct-current to direct-current (DC-DC) circuit 301, a second direct-current to direct-current circuit 501 and an inverter circuit 302. The first direct-current to direct-current circuit 301 includes at least a Boost Circuit, and the first direct-current to direct-current circuit 301 and the inverter circuit 302 are arranged in an inverter. An input terminal of the shutdown device 200 is connected to a photovoltaic panel 100, and an output terminal of the shutdown device 200 is connected to an input terminal of the first direct-current to direct-current circuit 301; an output terminal of the first direct-current to direct-current circuit 301 is connected to an input terminal of the inverter circuit 302; the second direct-current to direct-current circuit 501 is a bidirectional direct-current to direct-current circuit, and is configured to control charging and discharge of an energy storage battery. That is, in a case that the energy storage battery is charged, an electric energy of the direct-current bus is converted by the second direct-current to direct-current circuit 501 and transmitted to an energy storage battery 502; in a case that the energy storage battery 502 is discharged, an energy of the energy storage battery 502 is converted by the second direct-current to direct-current circuit 501 and transmitted to the direct-current bus.

A first terminal of the second direct-current to direct-current circuit 501 is connected to the input terminal of the inverter circuit 302, and a second terminal of the second direct-current to direct-current circuit 501 is connected the energy storage battery 502. The controller 400 is configured to start the inverter in multiple stages of the start-up process in a case that the start-up time of the inverter 200 is greater than a single turned-on period of the shutdown device, and the shutdown device 200 is turned on once in each stage.

In order to start the inverter, the start-up stage of the inverter is compressed and divided into several stages in the present disclosure. On one hand, the detection and execution time of each step is compressed, to shorten the total time of the start-up process. On the other hand, part of steps of the start-up process of the inverter are performed within a single turned-on period of the shutdown device (for example, a default period is 10 s) each time after the shutdown device is turned on. When the shutdown device is turned off after the current turned-on period of the shutdown device is over, the shutdown device is turned on again to perform a next part of steps of the start-up process of the inverter. Therefore, the shutdown device is turned on repeatedly for multiple number of times during the start-up process of the inverter, so that the inverter is started successfully.

The above description of the disclosed embodiments enables those skilled in the art to implement or use the present disclosure. Various modifications to these embodiments are apparent to those skilled in the art, and the generic principles defined herein may be practiced in other embodiments without departing from the spirit or scope of the present disclosure. Therefore, the present disclosure is not limited to the embodiments shown herein but is to be accorded the widest scope consistent with the principles and novel features disclosed herein.

1. A photovoltaic system, comprising a shutdown device, a controller and an inverter, wherein
the inverter comprises a direct-current to direct-current circuit and an inverter circuit, and the direct-current to direct-current circuit comprises at least a Boost circuit, and wherein
an input terminal of the shutdown device is connected to a photovoltaic panel, and an output terminal of the shutdown device is connected to an input terminal of the direct-current to direct-current circuit, and an output terminal of the direct-current to direct-current circuit is connected to an input terminal of the inverter circuit; and
the controller is configured to control the inverter to perform a start-up process in a plurality of stages in a case that a start-up time of the inverter is greater than a single turned-on period of the shutdown device, wherein the shutdown device is turned on once in each of the plurality of stages.

2. The photovoltaic system according to claim 1, wherein the plurality of stages comprises at least: an insulation resistance detection stage, a relay detection stage, and an inverter open-loop self-test stage, and wherein a relay is connected with an output terminal of the inverter, and
the controller is further configured to control, if the start-up process fails in at least one of the plurality of stages, the inverter to re-perform the start-up process in a plurality of stages.

3. The photovoltaic system according to claim 2, wherein during the start-up process of the inverter, the controller is further configured to turn on the shutdown device and turn off the shutdown device in a case that a single turned-on period is over; and turn on the shutdown device again, and perform insulation resistance detection in a case that the shutdown device is turned on.

4. The photovoltaic system according to claim 3, wherein
the shutdown device is turned off after the insulation resistance detection is performed by the controller, and
the shutdown device is turned on again by the controller, and relay self-test is performed in a case that the shutdown device is turned on.

5. The photovoltaic system according to claim 4, wherein
the shutdown device is turned off after the relay self-test is performed by the controller, and
the shutdown device is turned on again by the controller, and the controller is configured to perform power self-test of the inverter in a case that the shutdown device is turned on, and further configured to close the relay after the power self-test of the inverter is performed.

6. The photovoltaic system according to claim 1, wherein the shutdown device is further configured to detect an output current of the shutdown device and is turned off if the output current is less than a preset current.

7. The photovoltaic system according to claim 1, wherein the input terminal of the inverter circuit is connected to at least one Boost circuit.

8. A method for starting an inverter of a photovoltaic system, wherein the photovoltaic system comprises: a shutdown device, a controller and an inverter; the inverter comprises a direct-current to direct-current circuit and an inverter circuit; the direct-current to direct-current circuit comprises at least two Boost circuits; an input terminal of the shutdown device is connected to a photovoltaic panel, and an output terminal of the shutdown device is connected to an input terminal of the direct-current to direct-current circuit; an output terminal of the direct-current to direct-current circuit is connected to an input terminal of the inverter circuit, and wherein
the method comprises:
controlling the inverter to perform a start-up process in a plurality of stages in a case that a start-up time of the inverter is greater than a single turned-on period of the shutdown device, wherein the shutdown device is turned on once in each of the plurality of stages.

9. The method according to claim 8, wherein the plurality of stages comprises at least: an insulation resistance detection stage, a relay detection stage, and an inverter open-loop self-test stage, and a relay is connected with an output terminal of the inverter, and wherein
the method further comprises: controlling the inverter to re-perform the start-up process in a plurality of stages in a case that the start-up process fails in at least one of the plurality of stages.

10. The method according to claim 9, wherein performing insulation resistance detection in a case that the shutdown device is turned on comprises:
during the start-up process of the inverter, turning on the shutdown device, and turning off the shutdown device in a case that a set delay period is over; and turning on the shutdown device again by the controller, and performing the insulation resistance detection by the controller in a case that the shutdown device is turned on.

11. The method according to claim 10, wherein performing bus voltage generation in a case that the shutdown device is turned on comprises:
turning on the shutdown device again; and
performing relay self-test in a case that the shutdown device is turned on.

12. The method according to claim 11, wherein performing power self-test of the inverter in a case that the shutdown device is turned on comprises:
turning on the shutdown device again, and performing power self-test of the inverter by the controller in a case that the shutdown device is turned on, and controlling the relay to be closed by the controller after the power self-test of the inverter is performed.

13. A photovoltaic energy storage system, comprising: a shutdown device, a controller, a first direct-current to direct-current circuit, a second direct-current to direct-current circuit and an inverter circuit, wherein
the first direct-current to direct-current circuit comprises at least a Boost circuit, and the first direct-current to direct-current circuit and the inverter circuit are arranged in an inverter, and wherein
an input terminal of the shutdown device is connected to a photovoltaic panel, and an output terminal of the shutdown device is connected to an input terminal of the first direct-current to direct-current circuit; an output terminal of the first direct-current to direct-current circuit is connected to an input terminal of the inverter circuit; the second direct-current to direct-current circuit is a bidirectional direct-current to direct-current circuit, a first terminal of the second direct-current to direct-current circuit is connected to an input terminal of the inverter circuit, and a second terminal of the second direct-current to direct-current circuit is configured to connect to an energy storage battery; and
the controller is configured to control the inverter to perform a start-up process in a plurality of stages in a case that a start-up time of the inverter is greater than a single turned-on period of the shutdown device, wherein the shutdown device is turned on once in each of the plurality of stages.
